(19) United States
(12) Patent Application Publication
(10) Pub. No.: US 2006/0003173 A1
(43) Pub. Date: Jan. 5, 2006

(54) Flexible metal foil/polyimide laminate and making method

(75) Inventors: Masahiro Usuki, Kashima-gun (JP); Makoto Fujiwara, Kashima-gun (JP); Shigehiro Hoshida, Kashima-gun (JP); Michio Aizawa, Kashima-gun (JP); Tadashi Amano, Kashima-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 11/171,198

(22) Filed: Jul. 1, 2005

(30) Foreign Application Priority Data
Jul. 5, 2004 (JP) 2004-197759

(51) Int. Cl. B32B 15/08

(52) U.S. Cl. 428/458

(57) ABSTRACT

In a flexible metal foil/polyimide laminate comprising in sequence, a heat resistant polyimide film, an adhesive layer, and a metal foil, the adhesive layer is a polyimide adhesive layer with a Tg of at least 400° C., obtained by heat imidization of a polyamic acid varnish containing 5-200 ppm of a leveling agent, typically polyether-modified silicone. This laminate of the all polyimide type takes full advantage of the properties of heat resistant polyimide film, includes the adhesive layer having a smooth surface, and is free of thickness variations.

### CROSS-REFERENCE TO RELATED APPLICATION

This non-provisional application claims priority under 35 U.S.C. §119(a) on Patent Application No. 2004-197759 filed in Japan on Jul. 5, 2004, the entire contents of which are hereby incorporated by reference.

### TECHNICAL FIELD

This invention relates to a flexible metal foil/polyimide laminate, and a method for preparing the same by a laminating process. More particularly, it relates to a flexible metal foil/polyimide laminate comprising a heat resistant polyimide film and a metal foil stacked on one surface of the film with a heat resistant adhesive layer intervening therebetween, and a method for preparing the same.

### BACKGROUND ART

Prior art flexible metal foil laminates are generally manufactured by bonding metal foils to commercially available polyimide films with adhesives such as epoxy resins. The heat resistance, chemical resistance, flame retardance, electrical and other properties of such laminates are governed by the properties of a particular adhesive used. The laminates do not take full advantage of the favorable properties of polyimide film and are insufficient especially in heat resistance. To overcome the drawbacks of prior art flexible metal foil laminates using adhesives, an adhesive layer-free flexible metal foil/polyimide laminate has been developed which is manufactured by casting, coating and curing a polyimide resin or polyimide resin precursor (polyamic acid) varnish directly onto a metal foil.

For example, a method of laminating a plurality of layers of polyimide resins having different chemical structures to prevent curling due to shrinkage during polyimide resin formation has been reported. In this case, the polyimide resin of the layer in contact with the metal foil generally has a lower glass transition temperature (Tg) than the polyimide resins of the remaining layers in order to ensure a bond strength to the metal foil. When an adhesive layer-free flexible metal foil/polyimide laminate is manufactured by casting, coating and curing a polyimide resin or polyimide resin precursor varnish directly onto a metal foil, many defects like drying thickness variations, orange peel texture, depressions and cissing (pits) occur on the coating surface at the stage when the solvent is first evaporated after varnish application. If a multilayer flexible metal foil laminate is manufactured without eliminating such defects, they cause the resulting laminate to suffer thickness variations and losses of electrical properties and flexural properties. Likewise for preventing curling, modified polyimide resins, for example, silicone-modified polyimide resins and polyamide-imides are sometimes used.

These flexible metal foil laminates are significantly improved in heat resistance and the like as compared with the prior art flexible metal foil laminates having an adhesive layer of epoxy resin, but are not regarded as fully taking advantage of the favorable properties of polyimide film because of the presence of a polyimide adhesive layer with low Tg. In Japanese Patent No. 3,320,516, for example, the polyimide resin responsible for adhesion (Synthesis Example 1) has a Tg of 192° C., which is far below the Tg (430° C.) of commercially available polyimide film (trade name Kapton H by Dupont-Toray Co., Ltd.).

There is still a desire to have a flexible metal foil/polyimide laminate which fully takes advantage of the favorable properties of polyimide film, uses an adhesive layer having a smooth surface, and is free of thickness variations.

### DISCLOSURE OF THE INVENTION

An object of the invention is to provide a flexible metal foil/polyimide laminate of the all polyimide type that takes full advantage of the properties of heat resistant polyimide film such as heat resistance, chemical resistance, flame retardance and electrical properties, uses an adhesive layer having a smooth surface, and is free of thickness variations.

The inventor has found that the above and other objects are achieved by using a polyimide adhesive layer obtained by heat imidization of a polyamic acid varnish containing a specific amount of a leveling agent and having a glass transition temperature of at least 400° C., as the adhesive layer between the polyimide film and the metal foil.

More particularly, by applying a varnish of polyamic acid (or polyimide resin precursor) containing 5 to 200 ppm of a leveling agent based on the weight of polyamic acid solids onto a metal foil, drying, joining a polyimide film to the metal foil with the varnish coating interposed therebetween, removing the residual solvent from the adhesive layer and effecting imidization, a flexible metal foil/polyimide laminate of the all polyimide type consisting of three layers: polyimide film, polyimide adhesive layer and metal foil is obtained. This laminate takes full advantage of the properties of heat resistant polyimide film such as heat resistance, chemical resistance, flame retardance and electrical properties, uses the adhesive layer having a smooth surface, and has eliminated thickness variations and surface cissing or pits.

In one aspect, the present invention provides a flexible metal foil/polyimide laminate comprising a heat resistant polyimide film and a metal foil stacked on one surface of the film with a heat resistant adhesive layer intervening therebetween. The heat resistant adhesive layer is a polyimide adhesive layer obtained by heat imidization of a polyamic acid varnish containing 5 to 200 ppm of a leveling agent based on the weight of polyamic acid solids. The polyimide adhesive layer has a glass transition temperature Tg of at least 400° C.

In another aspect, the present invention provides a method for preparing a flexible metal foil/polyimide laminate as defined above, comprising the steps of applying a polyamic acid varnish containing a leveling agent onto a metal foil and drying to form a varnish coating, laminating a heat resistant polyimide film to the varnish-coated metal foil using a heat roll, and heating the laminate at a temperature in the range of 200 to 400° C. for imidization.

With the method of the invention, a flexible metal foil/polyimide laminate of the all polyimide type featuring high heat resistance and free of drawbacks like thickness variations and cissing is obtainable.

### BEST MODE FOR CARRYING OUT THE INVENTION

The flexible metal foil/polyimide laminate of the invention comprises a heat resistant polyimide film, a polyimide adhesive layer formed on one surface of the film, and a metal foil stacked on the polyimide adhesive layer, the polyimide adhesive layer being obtained by heat imidization of a polyamic acid varnish containing a leveling agent. The invention is characterized by the use of a polyamic acid having added thereto a leveling agent for establishing a bond between the heat resistant polyimide film and the metal foil.

In the flexible metal foil/polyimide laminate of the invention, the polyamic acid used as the adhesive may be prepared by reacting an aromatic diamine compound of the general formula (I) with an aromatic tetracarboxylic acid anhydride of the general formula (II), shown below, in a suitable solvent.
H₂N—R¹—NH₂ (I)
Herein R¹ is a divalent radical selected from the group consisting of an aliphatic radical, cycloaliphatic radical, monocyclic aromatic radical, fused polycyclic aromatic radical and non-fused cyclic aromatic radical having aromatics joined directly or via a linking member. 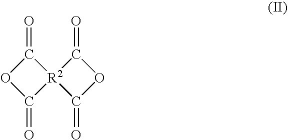
Herein R² is a tetravalent radical selected from the group consisting of an aliphatic radical, cycloaliphatic radical, monocyclic aromatic radical, fused polycyclic aromatic radical and non-fused cyclic aromatic radical having aromatics joined directly or via a linking member.

Examples of the diamine of general formula (I) include
o-phenylenediamine, m-phenylenediamine, p-phenylenediamine,
m-aminobenzylamine, p-aminobenzylamine,
2-chloro-1,2-phenylenediamine, 4-chloro-1,2-phenylenediamine,
2,3-diaminotoluene, 2,4-diaminotoluene, 2,5-diaminotoluene,
2,6-diaminotoluene, 3,4-diaminotoluene,
2-methoxy-1,4-phenylenediamine,
4-methoxy-1,3-phenylenediamine, benzidine,
3,3′-dichlorobenzidine, 3,3′-dimethylbenzidine,
3,3′-dimethoxybenzidine, 3,3′-diaminodiphenyl ether,
3,4′-diaminodiphenyl ether, 4,4′-diaminodiphenyl ether,
3,3′-diaminodiphenyl sulfide, 3,4′-diaminodiphenyl sulfide,
4,4′-diaminodiphenyl sulfide, 3,3′-diaminodiphenyl sulfoxide,
4,4′-diaminodiphenyl sulfoxide, 3,3′-diaminodiphenyl sulfone,
3,4′-diaminodiphenyl sulfone, 4,4′-diaminodiphenyl sulfone,
3,3′-diaminobenzophenone, 3,4′-diaminobenzophenone,
4,4′-diaminobenzophenone, 3,3′-diaminodiphenylmethane,
3,4′-diaminodiphenylmethane, 4,4′-diaminodiphenylmethane,
bis[4-(3-aminophenoxy)phenyl]methane,
bis[4-(4-aminophenoxy)phenyl]methane,
1,1-bis[4-(3-aminophenoxy)phenyl]ethane,
1,1-bis[4-(4-aminophenoxy)phenyl]ethane,
1,2-bis[4-(3-aminophenoxy)phenyl]ethane,
1,2-bis[4-(4-aminophenoxy)phenyl]ethane,
2,2-bis[4-(3-aminophenoxy)phenyl]propane,
2,2-bis[4-(4-aminophenoxy)phenyl]propane,
2,2-bis[4-(3-aminophenoxy)phenyl]butane,
2,2-bis[4-(4-aminophenoxy)phenyl]butane,
2,2-bis[4-(3-aminophenoxy)phenyl]-1,1,1,3,3,3-hexafluoropropane,
2,2-bis[4-(4-aminophenoxy)phenyl]-1,1,1,3,3,3-hexafluoropropane,
1,3-bis(3-aminophenoxy)benzene,
1,3-bis(4-aminophenoxy)benzene,
1,4-bis(3-aminophenoxy)benzene,
1,4-bis(4-aminophenoxy)benzene,
4,4′-bis(3-aminophenoxy)biphenyl,
4,4′-bis(4-aminophenoxy)biphenyl,
bis[4-(3-aminophenoxy)phenyl]ketone,
bis[4-(4-aminophenoxy)phenyl]ketone,
bis[4-(3-aminophenoxy)phenyl]sulfide,
bis[4-(4-aminophenoxy)phenyl]sulfide,
bis[4-(3-aminophenoxy)phenyl]sulfoxide,
bis[4-(4-aminophenoxy)phenyl]sulfoxide,
bis[4-(3-aminophenoxy)phenyl]sulfone,
bis[4-(4-aminophenoxy)phenyl]sulfone,
bis[4-(3-aminophenoxy)phenyl]ether,
bis[4-(4-aminophenoxy)phenyl]ether,
1,4-bis[4-(3-aminophenoxy)benzoyl]benzene,
1,3-bis[4-(3-aminophenoxy)benzoyl]benzene,
4,4-bis[3-(4-aminophenoxy)benzoyl]diphenyl ether,
4,4-bis[3-(3-aminophenoxy)benzoyl]diphenyl ether,
4,4-bis[4-(4-amino-α,α-dimethylbenzyl)phenoxy]benzophenone,
4,4-bis[4-(4-amino-α,α-dimethylbenzyl)phenoxy]diphenyl sulfone,
bis[4-([4-(4-aminophenoxy)phenoxy]phenyl]ketone,
bis[4-([4-(4-aminophenoxy)phenoxy]phenyl]sulfone,
1,4-bis[4-(4-aminophenoxy)-α,α-dimethylbenzyl]benzene, and
1,3-bis[4-(4-aminophenoxy)-α,α-dimethylbenzyl]benzene, which may be used alone or in admixture of any.

Of the diamine compounds illustrated above, preferred are p-phenylenediamine and 4,4′-diaminodiphenyl ether.

The tetracarboxylic acid dianhydrides of the general formula (II) include
those of formula (II) wherein R² is an aliphatic radical, such as ethylenetetracarboxylic dianhydride;
those of formula (II) wherein R² is a cycloaliphatic radical, such as cyclopentanetetracarboxylic dianhydride;
those of formula (II) wherein R² is a monocyclic aromatic radical, such as 1,2,3,4-benzenetetracarboxylic dianhydride and pyromellitic dianhydride;
those of formula (II) wherein R² is a fused polycyclic aromatic radical, such as
2,3,6,7-naphthalenetetracarboxylic dianhydride,
1,4,5,8-naphthalenetetracarboxylic dianhydride,
1,2,5,6-naphthalenetetracarboxylic dianhydride,
3,4,9,10-perillenetetracarboxylic dianhydride,
2,3,6,7-anthracenetetracarboxylic dianhydride, and
1,2,7,8-phenanthrenetetracarboxylic dianhydride;
   those of formula (II) wherein R² is a non-fused cyclic aromatic radical having aromatics joined directly, such as
3,3′,4,4′-biphenyltetracarboxylic dianhydride and
2,2′,3,3′-biphenyltetracarboxylic dianhydride; and
   those of formula (II) wherein R² is-a non-fused cyclic aromatic radical having aromatics joined via a linking member, such as 3,3′,4,4′-benzophenonetetracarboxylic dianhydride,
2,2′,3,3′-benzophenonetetracarboxylic dianhydride,
2,2-bis(3,4-dicarboxyphenyl)propane dianhydride,
2,2-bis(2,3-dicarboxyphenyl)propane dianhydride,
bis(3,4-dicarboxyphenyl)ether dianhydride,
bis(3,4-dicarboxyphenyl)sulfone dianhydride,
bis(2,3-dicarboxyphenyl)sulfone dianhydride,
1,1-bis(2,3-dicarboxyphenyl)ethane dianhydride,
bis(2,3-dicarboxyphenyl)methane dianhydride,
bis(3,4-dicarboxyphenyl)methane dianhydride,
4,4′-(p-phenylenedioxy)diphthalic dianhydride and
4,4′-(m-phenylenedioxy)diphthalic dianhydride, which may be used alone or in admixture of any.

Of the tetracarboxylic dianhydrides illustrated above, preferred are pyromellitic dianhydride and 3,3′,4,4′-biphenyltetracarboxylic dianhydride.

For the reaction, the aromatic diamine and the aromatic tetracarboxylic anhydride are preferably used in a molar ratio of from 0.95:1.00 to 1.05:1.00.

Examples of the solvent used herein include N-methylpyrrolidone (NMP), dimethylformamide (DMF), dimethylacetamide (DMAc), dimethyl sulfoxide (DMSO), dimethyl sulfate, sulfolane, butyrolactone, cresol, phenol, halogenated phenols, cyclohexanone, dioxane, tetrahydrofuran and diglyme. Of these, DMAc and NMP are preferred for the dissolution of polyamic acid and the storage stability of varnish. The amount of the solvent used is not critical and may be determined as appropriate.

The mode of reaction of diamine with acid anhydride is not particularly limited. Any of prior art well-known methods is applicable. Typically, the reaction is carried out in a nitrogen atmosphere at a temperature of 10 to 40° C. Also the way of dissolving and adding the reactants is not critical.

According to the invention, a leveling agent is added to the polyamic acid varnish thus obtained. The leveling agent added improves the surface smoothness of the adhesive layer of the varnish to be disposed between the metal foil and the polyimide film, ensuring the manufacture of a laminate with minimized thickness variation.

The leveling agent used herein is typically selected from dimethylsilicones and polyether-modified silicones, and preferably polyether-modified silicones. The preferred polyether-modified silicones are typically of the following formula. 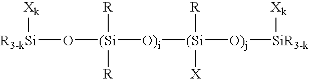
Herein, R which is the same or different is selected from alkyl, aryl, aralkyl and fluoroalkyl radicals of 1 to 10 carbon atoms. X is an alkyl ether radical represented by —CₚH₂ₚO(C₂H₄O)ₐ(C₃H₆O)_{b}R′ wherein R′ is a C₁-C₆ alkyl radical, acetyl radical or hydrogen atom, p is an integer of 2 to 6, a is an integer of at least 1, and b is 0 or an integer of at least 1. The subscript i is an integer of at least 1, j is 0 or an integer of at least 1, k is 0 or 1, and both j and k are not equal to 0 at the same time.

More particularly, R is selected from alkyl, cycloalkyl, aryl, aralkyl and fluoroalkyl radicals of 1 to 10 carbon atoms, for example, alkyl radicals such as methyl, ethyl, propyl, butyl, pentyl, hexyl, heptyl, octyl, nonyl, decyl, cycloalkyl radicals such as cyclopentyl and cyclohexyl, aryl radicals such as phenyl and tolyl, aralkyl radicals such as benzyl and phenethyl, and fluoroalkyl radicals such as trifluoropropyl and heptadecafluorodecyl. Methyl is most preferred.

Examples of R′ include a hydrogen atom, alkyl radicals such as methyl, ethyl, propyl, butyl, pentyl and hexyl and an acetyl radical. The subscript i is an integer of at least 1, j is 0 or an integer of at least 1, and the sum of i+j is preferably in a range of 5 to 100. The subscript k is 0 or 1. Both j and k are not equal to 0 at the same time. The subscript a is an integer of at least 1, and b is 0 or an integer of at least 1, and the sum of a+b is preferably in a range of 3 to 60.

Suitable leveling agents which can be used herein are commercially available, for example, under the trade name of KP341 and KF352A from Shin-Etsu Chemical Co., Ltd. and SH30PA from Dow Corning-Toray Co., Ltd. They may be used alone or in admixture.

An appropriate amount of the leveling agent added is 5 to 200 parts by weight per million parts by weight of solids of the polyamic acid. The preferred amount of the leveling agent is 5 to 50 ppm based on the weight of polyamic acid solids. Less than 5 ppm of the leveling agent fails to exert its effect whereas more than 200 ppm can cause cissing on the coating surface or defects on the coating surface due to degraded compatibility with the varnish. It is not critical how to admix the leveling agent with the polyamic acid varnish, and any of well-known admixing techniques may be employed.

It is also acceptable to add to the polyamic acid varnish, surfactants for further enhancing the coating surface smoothness, and additives and fillers for improving other properties.

According to the present invention, the polyamic acid varnish, after imidization, should have a glass transition temperature Tg of at least 400° C., preferably 400° C. to 500° C., because a Tg in this range ensures the manufacture of a laminate having very high heat resistance. If Tg after imidization is lower than 400° C., the polyimide layer can be undesirably deformed by heat when the semiconductor mounting includes heating at or above 400° C.

The polyimide film used in the preparation of the flexible metal foil/polyimide laminate of the invention may be any of polyimide films that are conventionally used in laminates of this type. There may be used films of polyimide resins comprising recurring units of the general formula (III), shown below, which are obtained from diamine compounds of the above general formula (I) and tetracarboxylic acid dianhydrides of the above general formula (II). 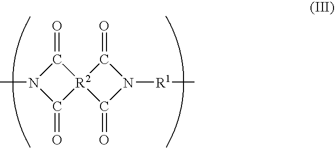
Herein R¹ and R² are as defined above.

The method of preparing the polyimide film is not particularly limited, and any of prior art well-known methods is applicable. Commercial products may also be used instead. Examples of commercial products that can be used herein include Apical® by Kaneka Corp. and Kapton® by Dupont-Toray Co., Ltd.

The thickness of the polyimide film is not particularly limited and may be suitably selected although it is generally in a range of 10 to 50 μm, and preferably 12 to 25 μm. In addition, the polyimide film used herein generally has a Tg of at least 400° C., and preferably 400° C. to 500° C.

It is also acceptable to add to the polyimide film, surfactants for further enhancing the surface smoothness, and additives and fillers for improving other properties. The polyimide film may be suitably pretreated such as by corona treatment, etching treatment or plasma treatment for further improving the adhesion thereof.

On the other hand, the type of the metal foil used herein is not critical. Often, copper, nickel, aluminum, stainless steel and beryllium-copper alloys are used. Copper foil is most often used as the metal foil for forming printed circuits. The copper foil used herein may be either rolled copper foil or electrolytic copper foil. To enhance the bond strength between a metal foil and a polyimide in direct contact therewith, a layer of inorganic matter, typically elemental metal or an oxide or alloy thereof may be formed on the metal foil. In the case of a copper foil, for example, a layer of elemental copper, copper oxide, nickel-copper alloy or zinc-copper alloy may be formed on the metal foil. Alternatively, instead of the inorganic matter, coupling agents such as aminosilanes, epoxysilanes and mercaptosilanes may be coated onto the metal foil.

The thickness of the metal foil is not particularly limited and may be suitably selected although it is generally in a range of 3 to 50 μm, preferably 9 to 35 μm.

In the flexible metal foil/polyimide laminate of the invention, a heat resistant adhesive layer formed by heat imidization of the polyamic acid varnish (also referred to as polyimide adhesive layer) intervenes between the polyimide film and the metal foil.

The polyimide adhesive layer is preferably obtained by applying the polyamic acid varnish onto a polyimide film or a metal foil, drying the coating, joining the polyimide film and the metal foil together with the varnish coating interposed therebetween, then effecting imidization. More preferably, the polyimide adhesive layer is obtained by applying the polyamic acid varnish onto a metal foil, half drying the coating with the polyamic acid varnish state kept, laying a polyimide film thereon and joining thereto, removing the solvent in the varnish, and effecting imidization

The apparatus and technique used in the step of applying the polyamic acid varnish are not particularly limited. There are available a variety of coaters including comma coaters, gravure coaters, and die coaters, any of which may be used herein. Coating using a suitable tool like brush is also acceptable. The polyamic acid varnish as applied should preferably be processed into a semi-dry state (having a solvent content of 3 to 50% by weight), which is typically achieved by drying at 80 to 120° C. for about 1 to 20 minutes.

The technique of joining the metal foil and the polyimide film together through a polyimide adhesive layer is not particularly limited. A suitable technique like pressing or laminating technique may be employed.

Once the metal foil and the polyimide film are joined together, the solvent is removed from the polyimide adhesive layer (or polyamic acid varnish) by any desired technique, preferably by heating at 40 to 170° C. for about 3 to 30 hours. Imidization may be effected by ordinary techniques, preferably by heating at 200° C. to 400° C. Heating at 300° C. to 400° C. is more preferred because the time required for imidization is reduced, with an increased productivity. The polyimide adhesive layer thus obtained preferably has a thickness of 1 to 10 μm, more preferably 2 to 5 μm.

The laminate of the invention permits intentional combination of a polyimide film with a polyimide adhesive layer, which enables to form a polyimide/metal foil laminate having certain focused properties. For example, using a plasma-pretreated polyimide film, a flexible metal foil/polyimide laminate having good bond strength to a polyimide adhesive layer is obtainable. (Although the polyimide adhesive layer of the metal foil/polyimide laminate can be plasma treated prior to the lamination, the use of a plasma-pretreated polyimide film is industrially advantageous.) This flexible metal foil/polyimide laminate is very useful in the manufacture of multilayer flexible printed circuit boards using an adhesive sheet.

In HDD and optical pickup applications, for example, flexible metal foil/polyimide laminates having improved flexural property and improved flexibility are desirable. The flexural property becomes better as the polyimide adhesive layer in contact with the metal foil has a higher modulus of elasticity or higher Tg. On the other hand, the flexibility becomes better as the entire polyimide resin layer has a lower modulus of elasticity. Therefore, a flexible metal foil/polyimide laminate for a particular purpose can be manufactured by joining a polyimide film having a medium to low modulus of elasticity using a polyimide adhesive layer having a high modulus of elasticity and a high Tg.

### EXAMPLE

Synthesis Examples, Examples and Comparative Examples are given below by way of illustration of the invention although the invention is not limited thereto.

### Synthesis Example 1

A three-necked flask equipped with a stirrer and a dropping funnel was placed in an ice water bath and nitrogen gas was flowed. The flask was charged with 30.0 g of 3,3′,4,4′-biphenyltetracarboxylic dianhydride and 200 g of dimethylacetamide (DMAc), which were stirred for 30 minutes. Then 10.8 g of p-phenylenediamine in 200 g of DMAc was added over 15 minutes from the dropping funnel. The resulting mixture was stirred at 10-15° C. for 2 hours and at 25° C. for 6 hours, yielding a homogeneous polyimide resin precursor varnish A comprising polyamic acids.

### Synthesis Example 2

A polyimide resin precursor varnish B was prepared as in Synthesis Example 1 except that 20.9 g of bis(4-aminophenoxyphenyl)propane was used as the diamine and 10.9 g of pyromellitic dianhydride used as the acid anhydride.

### Examples 1 and 2

Laminates were fabricated by the procedure described below while using a polyimide film, varnish and leveling agent as shown in Table 1, and effecting imidization under conditions as shown in Table 1. The laminates thus obtained were determined for thickness variation, peel strength, and soldering heat resistance. The number of pits (by cissing) in the coating and drying steps was counted. The Tg of the polyimide layer was measured. The results are shown in Table 1.

### Comparative Example 1

A laminate was fabricated as in Example 1, aside from omitting the leveling agent.

### Comparative Example 2

A laminate was fabricated as in Example 1, aside from adding 250 ppm of the leveling agent.

### Comparative Example 3

A laminate was fabricated as in Example 1, aside from using varnish B.

Laminate Fabrication

Using an applicator, the polyamic acid varnish of Synthesis Example to which the leveling agent shown in Table 1 had been admixed was applied onto a rolled copper foil of 35 μm thick and sized 30 cm×25 cm to a liquid thickness of 50 μm. This was dried in an oven at 120° C. for 2 minutes. A polyimide film of 25 μm thick and sized 30 cm×25 cm was laid thereon. A test roll laminating machine (by Nishimura Machinery Co., Ltd.) was run to carry out lamination at 120° C. and 15 kg/cm at a rate of 4 m/min. In a N2 inert oven, the laminate was successively heat treated in three stages: Step 1 of solvent drying at 160° C. for 4 hours, Step 2 of heating at 250° C. for 1 hour and Step 3 of heating at 350° C. for 3 hours for imidization. The resulting laminate included the copper foil of 35 μm thick and the polyimide layer of 35 μm thick.

Measurement of Peel Strength

For a sample having circuits of 1 mm wide formed thereon, peel strength was measured at a pulling speed of 50 mm/min and a peeling angle of 90° according to JIS C-6471.

Measurement of Thickness Variation

The thickness of the laminate was measured at 20 points, and the difference between maximum and minimum thicknesses was reported as thickness variation.

Measurement of Pits

During the laminate fabrication procedure, the number of pits (caused by cissing) on the coating surface was visually counted at the end of the coating and drying step.

Measurement of Soldering Heat Resistance

A laminate sample (25 mm long×25 mm wide) was immersed in a solder bath at 380° C. for 30 seconds after which it was visually inspected for peeling and blisters and rated according to the following criterion.

Rating
ο: no peel nor blister
χ: peeled or blisters
   Measurement of Tg

The laminate of Example or Comparative Example was immersed in a ferric chloride aqueous solution for etching for thereby completely removing the copper foil from the laminate. This was followed by water washing and drying, leaving a sheet sample consisting of the polyimide layer. The Tg of the sheet sample was measured using a thermal analyzer Model RSA-III (Rheometric Science).

TABLE 1

| | | Example | | Comparative Example | | |
|---|---|---|---|---|---|---|
| | | 1 | 2 | 1 | 2 | 3 |
| Polyimide film | | Apical NPI* | Apical NPI* | Apical NPI* | Apical NPI* | Apical NPI* |
| Polyamic acid varnish | | A | A | A | A | B |
| Leveling | Type** | a | b | — | a | b |
| agent | Amount | 30 ppm | 100 ppm | — | 250 ppm | 100 ppm |
| Drying/ | Step 1 | 160° C./4 hr | 160° C./4 hr | 160° C./4 hr | 160° C./4 hr | 160° C./4 hr |
| imidization | Step 2 | 250° C./1 hr | 250° C./1 hr | 250° C./1 hr | 250° C./1 hr | 250° C./1 hr |
| | Step 3 | 350° C./3 hr | 350° C./3 hr | 350° C./3 hr | 350° C./3 hr | 350° C./3 hr |

| | | | | | |
|---|---|---|---|---|---|
| Test results | | | | | |
| Tg (° C.) of polyimide layer | 420 | 420 | 420 | 420 | 220 |
| Number of pits | 0 | 0 | 3 | 3 | 0 |
| Thickness variation (μm) | 0 | 0 | 3 | 3 | 0 |
| Soldering heat resistance | ∘ | ∘ | ∘ | ∘ | x |
| 90° peel strength (kg/cm) | 0.8 | 0.8 | 0.8 | 0.7 | 0.6 |

*Apical NPI (25 μm) by Kaneka Corp.
**Leveling agents:
a: KF352A, polyether-modified silicone by Shin-Etsu Chemical Co., Ltd.
b: KP341, polyether-modified silicone by Shin-Etsu Chemical Co., Ltd.

Japanese Patent Application No. 2004-197759 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A flexible metal foil/polyimide laminate comprising a heat resistant polyimide film and a metal foil stacked on one surface of the film with a heat resistant adhesive layer intervening therebetween,
said heat resistant adhesive layer being a polyimide adhesive layer obtained by heat imidization of a polyamic acid varnish containing 5 to 200 ppm of a leveling agent based on the weight of polyamic acid solids,
the polyimide adhesive layer having a glass transition temperature of at least 400° C.

2. The laminate of claim 1 wherein said metal foil is a rolled or electrolytic copper foil having a thickness of 9 μm to 35 μm.

3. A method for preparing a flexible metal foil/polyimide laminate as claimed in claim 1, comprising the steps of:
applying a polyamic acid varnish containing a leveling agent onto a metal foil and drying to form a varnish coating,
laminating a heat resistant polyimide film to the varnish-coated metal foil using a heat roll, and
heating the laminate at a temperature in the range of 200 to 400° C. for imidization.
